(19) United States
(12) Patent Application Publication
(10) Pub. No.: US 2014/0372728 A1
(43) Pub. Date: Dec. 18, 2014

(54) VECTOR EXECUTION UNIT FOR DIGITAL SIGNAL PROCESSOR

(71) Applicants: Anders Nilsson, Linkoping (SE); Eric Tell, Linkoping (SE)

(72) Inventors: Anders Nilsson, Linkoping (SE); Eric Tell, Linkoping (SE)

(73) Assignee: Media Tek Sweden AB, LINKÖPING (SE)

(21) Appl. No.: 14/364,651

(22) PCT Filed: Nov. 28, 2012
(86) PCT No.: PCT/SE2012/051322

§ 371 Date: Jun. 11, 2014

(30) Foreign Application Priority Data
Dec. 20, 2011 (SE) 1151232-4

(51) Int. Cl. G06F 9/30; G06F 15/78

(52) U.S. Cl. CPC G06F 9/30145; G06F 15/78
USPC 712/7

(57) ABSTRACT

A vector execution unit for use in a digital signal processor enables a new set of instructions. The unit comprises a first input port for receiving at least a first input data vector, an instruction decoder, a vector output port, and least one data-path. The instruction decoding unit is arranged to control the data-path to perform a comparison related to the first input data vector, and the processor comprises an integer port arranged to output the result of the comparison in the form of a decision vector to a memory unit or a functional unit in the digital signal processor. Alternatively or in addition, the integer port is also arranged to receive a decision vector of integer data, and the instruction decoding unit is arranged to control the data-path to process the first input data in dependence of the value of the integer data.

### TECHNICAL FIELD

The present invention relates to an execution unit for use in a digital signal processor, as defined in the preamble of claim 1. The invention also relates to a digital signal processor suitable for OFDM systems.

### BACKGROUND AND RELATED ART

For increased performance and reliability many mobile terminals presently use a type of Digital Signal Processor DSP known as a baseband processor (BBP), for handling many of the signal processing functions associated with processing of the received the radio signal and preparing signals for transmission. It is advantageous to separate such functions from the main processor, as they are highly timing dependent, and may require a realtime operating system. There is a desire that such baseband processors should be as flexible as possible to adapt to developing standards and enable hardware reuse. Therefore, programmable baseband processors, PBBP have been developed.

Many of the functions frequently performed in such processors are performed on large numbers of data samples. Therefore a type of processor known as Single Instruction Multiple Data (SIMD) processor is useful because it enables one single instruction to operate on multiple data items, rather than on one data item at a time. Multiple data items may be arranged in a vector, and a processing unit suitable for operating on a vector of data will be referred to in this document as a vector execution unit.

As a further development of SIMD architecture, the Single Instruction stream Multiple Tasks (SIMT) architecture has been developed. Traditionally in the SIIVIT architecture one or two SIMD type vector execution units have been provided in association with an integer execution unit which may be part of a core processor.

International Patent Application WO 2007018467 discloses a DSP according to the SIMT architecture, having a processor core including an integer processor and a program memory, and two vector execution units which are connected to, but not integrated in the core. The vector execution units may be Complex Arithmetic Logic Units (CALU) or Complex Multiply-Accumulate Units (CMAC). The core has a program memory for distributing instructions to the execution units. In WO2007018467 each of the vector execution units has a separate instruction decoder. This enables the use of the vector execution units independently of each other, and of other parts of the processor, in an efficient way.

A prior art vector execution unit typically comprises a first and a second data input port for receiving data that is to be processed. The data may be complex or scalar data and may typically be in the form of data vectors. The vector execution unit also comprises an output port for feeding the result of the processing to another unit in the DSP. A particular type of vector execution unit, known as Complex Arithmetic and Logic Unit (CALU) is able to perform a very limited set of multiplications, in practice multiplication of data items with ±1±i. To this end the CALU also has an integer port. This integer port is arranged to receive integer data to control the multiplication.

### SUMMARY OF THE INVENTION

It is an objective of the present invention to provide new ways to use the SIMT type digital signal processor, and in particular increase the functionality of the vector execution units.

This object is achieved according to a first embodiment of the invention by a vector execution unit for use in a digital signal processor, said vector execution unit comprising:
A first vector input port for receiving at least a first input data vector from at least a first unit in the digital signal processor, respectively,
An instruction decoding unit arranged to decode instructions received from a program memory of the digital signal processor,
A vector output port for feeding the result of the instruction decoding to at least another unit in the digital signal processor,
At least one data-path.

The vector execution unit is characterized in that the instruction decoding unit is arranged to control the data-path to perform a comparison related to the first input data vector, and in that the processor comprises an integer port arranged to output the result of the comparison in the form of a decision vector to a memory unit or a functional unit in the digital signal processor.

This represents a new type of use of the vector execution unit in that the integer port is used for output of integer data. This in turn enables a new type of command, comparing two or more data items to produce an integer output indicating the result of the comparison. The output integer data may be stored in an integer memory for later use, or may be used directly as input data for another unit in the DSP.

Alternatively, or in addition, the vector execution unit may be characterized in that the integer port is arranged to receive a decision vector of integer data, and the instruction decoding unit is arranged to control the data-path to process the first input data in dependence of the value of the integer data.

By using the integer port to receive decision data that will influence the processing of data items a greater flexibility can be achieved. This embodiment is particularly useful for filtering functions in which values representing noise should be filtered out and actual signal values should be kept as they are. Other uses are of course perceivable as well.

In a preferred embodiment the vector execution unit is arranged both to generate a decision vector to be output on the integer port and to receive a decision vector to use as input for controlling the execution of instructions.

Preferably, the vector execution unit further comprises a second vector input port arranged to receive a second input data vector from a second unit in the digital signal processor, the instruction decoder being arranged to control the data-path to perform the comparison based on the first input data vector and the second input data vector.

The inventive vector execution unit may comprise one, two or more vector input ports, depending on the type of instructions it is to execute. If only one input data vector is received the vector execution unit may be arranged to perform a comparison between the first data and a constant.

The instruction decoding unit may be arranged to control the data-path to perform an arithmetic operation on the first andor second input data vector and use the result of the arithmetic operation in the comparison. This arithmetic operation may involve one or more of the data items received on the vector input ports. In this way, for example, squares or absolute values may be compared.

In the instruction decoder is arranged to control the data-path to perform two or more comparisons on the input data item and the decision vector will have one data item indicating the result of each comparison. The output decision vector may have only one data bit resulting from each comparison, or a number of bits indicating different properties of the input data. As a non-limiting example, three bits may be used to indicate if the input data item is greater than a particular value, if its absolute value his greater than zero and if the squared value is greater than some other value. In this case the vector execution unit arranged to use this decision vector must be arranged to pick the right value for each integer data item to be used as decision input.

In one embodiment the instruction decoder is arranged to control the data-path to perform the comparison on one data item from each input port at a time and output a vector of data having one or more data items for each comparison. In this way a number of comparisons of the same data items may be made at one time and the resulting decision vector may be used, for example, to control different functions.

A typical vector execution unit in the prior art has four data paths. In a vector execution unit having two or more data-paths, the instruction decoding unit may be arranged to control the data-paths to perform an arithmetic operation on the input data received on the two or more data-paths and use the result in the comparison. The input data received on two of the data-paths may be processed together and the input data received on the other two data-paths may be processed together and the comparison may be performed on the results of the processing. As the skilled person will understand, this can be extended to any number of data-paths.

The invention also relates to a digital signal processor comprising a program memory and at least one vector execution unit according to the invention.

### BRIEF DESCRIPTION OF THE DRAWINGS

FIG. 1 shows a digital signal processor in which a vector execution unit according to the present invention may be used.

FIG. 2 illustrates a vector execution unit according to an embodiment of the invention.

FIG. 3 illustrates the communication between the units involved according to a first embodiment of the invention.

FIG. 4 illustrates the communication between the units involved according to a second embodiment of the invention.

### DETAILED DESCRIPTION OF EMBODIMENTS

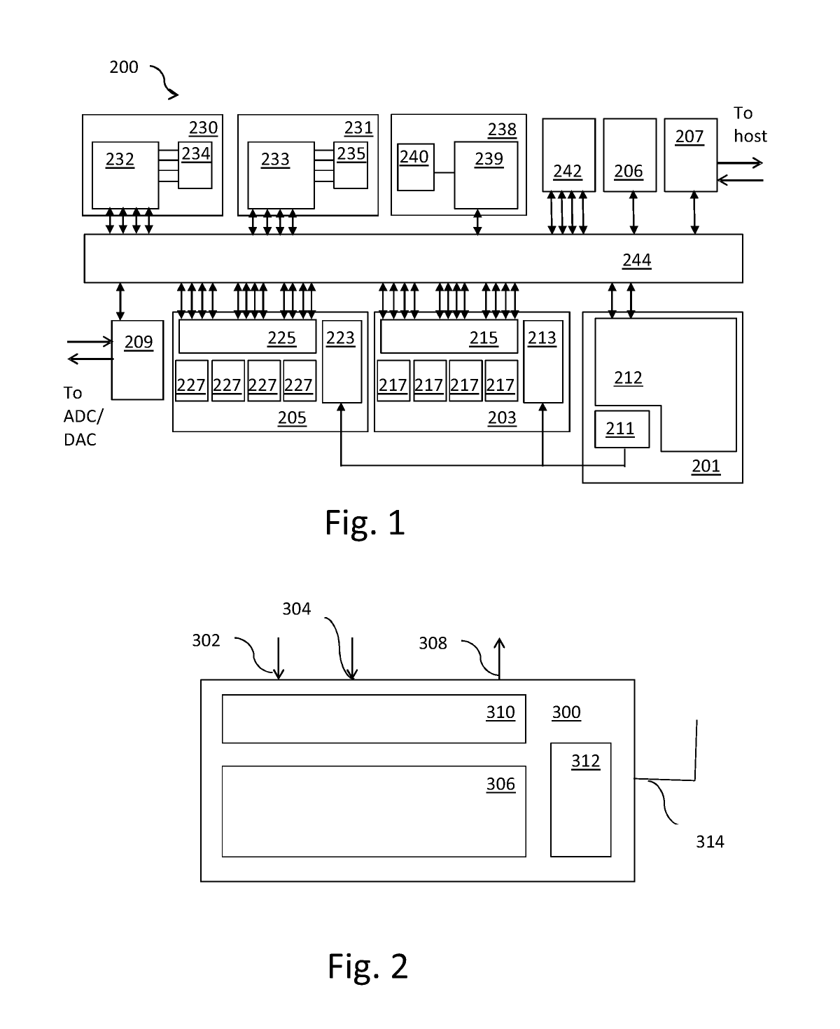

FIG. 1 shows a digital signal processor in which a vector execution unit according to the present invention may be used. FIG. 1 illustrates an example of a baseband processor 200 according to the SIIVIT architecture. The processor 200 includes a controller core 201 and a first 203 and a second 205 vector execution unit, which will be discussed in more detail below. A FEC unit 206 as discussed in FIG. 1 is connected to the on-chip network. In a concrete implementation, of course, the FEC unit 206 may comprise several different units.

A host interface unit 207 provides connection to the host processor (not shown). If a MAC processor is present, it is connected between the host interface unit 207 and the host processor. A digital front end unit 209 provides connection to an ADCDAC unit in a manner well known in the art.

As is common in the art, the controller core 201 comprises a program memory 211 as well as instruction issue logic and functions for multi-context support.

The controller core 201 also normally comprises an integer execution unit 212 comprising a register file RF, a core integer memory ICM, a multiplier unit MUL and an Arithmetic and LogicShift Unit (ALSU). These units are known in the art and are not shown in FIG. 1.

In this example each of the first vector execution unit 203 is a CMAC vector execution unit and the second vector execution unit 205 is a CALU vector execution unit, each comprising a vector controller 213, a vector loadstore unit 215 and a number of data paths 217. The load function is used for fetching data from the other units connected to the network 244 (for example from a memory bank) and the store function is used for storing data from the execution units 203, 205 to for example a memory unit 230, 231 through the network 244. Data may also be obtained from other vector execution units andor the computing results may be forwarded to other vector execution units for further processing. Each vector execution unit also comprises a vector controller 213, 223 arranged to receive instructions from the program memory 211.

The vector controller of this first vector execution unit is connected to the program memory 211 of the controller core 201 via the issue logic, to receive issue signals related to instructions from the program memory. In the description above, the issue logic decodes the instruction word to obtain the issue signal and sends this issue signal to the vector execution unit as a separate signal. It would also be possible to let the vector controller of the vector execution unit generate the issue signal locally. In this case, the issue signals are created by the vector controller based on the instruction word in the same way as it would be in the issue logic.

Alternatively, the vector execution units 203, 205 are CALU vector execution unit of a type known in the art, comprising a vector controller 223, a vector loadstore unit 225 and a number of data paths 227. The vector controller 223 of this second vector execution unit is also connected to the program memory 211 of the controller core 201, via the issue logic, to receive issue signals related to instructions from the program memory.

The vector execution units 203, 205 could also be any kind of vector execution units. Although two vector execution units are shown and discussed, the inventive method can be extended to sending the same instruction to three or more vector execution units.

There could be an arbitrary number of vector execution units, in addition to the two shown in FIG. 1. There may be only CMAC units, only CALU units or a suitable number of each type. There may also be other types of vector execution unit than CMAC and CALU. As explained above, a vector execution unit is a processor that is able to process vector instructions, which means that a single instruction performs the same function to a number of data units. Data may be complex or real, and are grouped into bytes or words and packed into a vector to be operated on by a vector execution unit. In this document, CALU and CMAC units are used as examples, but it should be noted that vector execution units may be used to perform any suitable function on vectors of data.

To enable several concurrent vector operations, the processor preferably has a distributed memory system where the memory is divided into several memory banks, represented in FIG. 1 by Memory bank 0 230 to Memory bank N 231. Each memory bank 230, 231 has its own complex memory 232, 233 and, address generation unit AGU 234, 235 respectively. The PBBP of FIG. 1 also includes one or more optional integer memory banks 238, including a memory 239 and an address generation unit 240.

As is known in the art, a number of accelerators 242 are typically connected, since they enable efficient implementation of certain baseband functions such as channel coding and interleaving. Such accelerators are well known in the art and will not be discussed in any detail here. The accelerators may be configurable to be reused by many different standards.

An on-chip network 244 connects the controller core 201, the digital front end unit 209, the host interface unit 207, the vector execution units 203, 205, the memory banks 230, 232, the integer bank 238 and the accelerators 242.

The first and second vector execution unit 203, 205 are shown as a four-way CMAC units with four complex datapaths that may be run concurrently or separately. The four complex data paths include multipliers, adders, and accumulator registers (all not shown in FIG. 1). Thus, in this embodiment, CMAC 203 may be referred to as a four-way CMAC datapath. In addition to multiplying and adding, CMAC 203 may also perform rounding and scaling operations and support saturation as is known in the art.

FIG. 2 is a simplified illustration of a vector execution unit 300 according to an embodiment of the invention. The vector execution unit may be a Complex Multiply and Accumulate (CMAC) unit, a Complex Arithmetic and Logical Unit (CALU) or any other type of processing unit that is capable of receiving and processing a vector of data. The vector execution unit of this example comprises a first 302 and a second 304 data input port for receiving data through the on-chip network. Data may be received through the on-chip network 244 from a memory unit, from another execution unit or from any other suitable unit in the DSP. The data are processed by a datapath 306 in the vector execution unit. The vector execution unit also has a data output port 308 for outputting the result to another unit through the on-chip network. The result may be fed to a memory unit, to another vector execution unit or to any other suitable unit in the DSP. A vector loadstore unit 310 is arranged between the input and output ports 302, 304, 308 and the datapath 306, to enable communication of data to and from the vector execution unit 300.

A vector control unit 312 is arranged to control the execution of instructions received from the core of the DSP (not shown in FIG. 2).

The data received on the input ports 302, 304 and output through the output port 308 will often be in the form of data vectors, which may have complex or scalar data. The datapath 306 is arranged to work on vectors of data by performing the same type of function on one data item from each vector at a time.

According to the invention, the vector execution unit also has an integer port 314 which in a first embodiment is arranged to output one or more bits indicating the result of the function performed by the datapath 306. For example, the datapath 306 may be arranged to perform a comparison, as will be discussed in the following. The result of the comparison may be indicated by one or more bits, which may be output on the integer port 314. The result of the comparison of each of the input data items in the input vectors will be a vector of integer data items each comprising one or more bits.

The resulting decision vector may be sent to an integer memory unit to be stored there. It may then later be retrieved by a functional unit, such as an execution unit or an accelerator, to be used as decision input data by this functional unit. It may also be sent directly to the functional unit to influence its data processing.

In a second embodiment the vector execution unit 300 is arranged to receive an integer vector through the integer port 314 and use this integer vector as control data for its next instruction. For example, the vector execution unit may be arranged to perform a particular function on the input data if the integer data item is 1 and another function if the integer data item is 0.

Of course, in practice, the first and second embodiments may be implemented in the same vector execution unit.

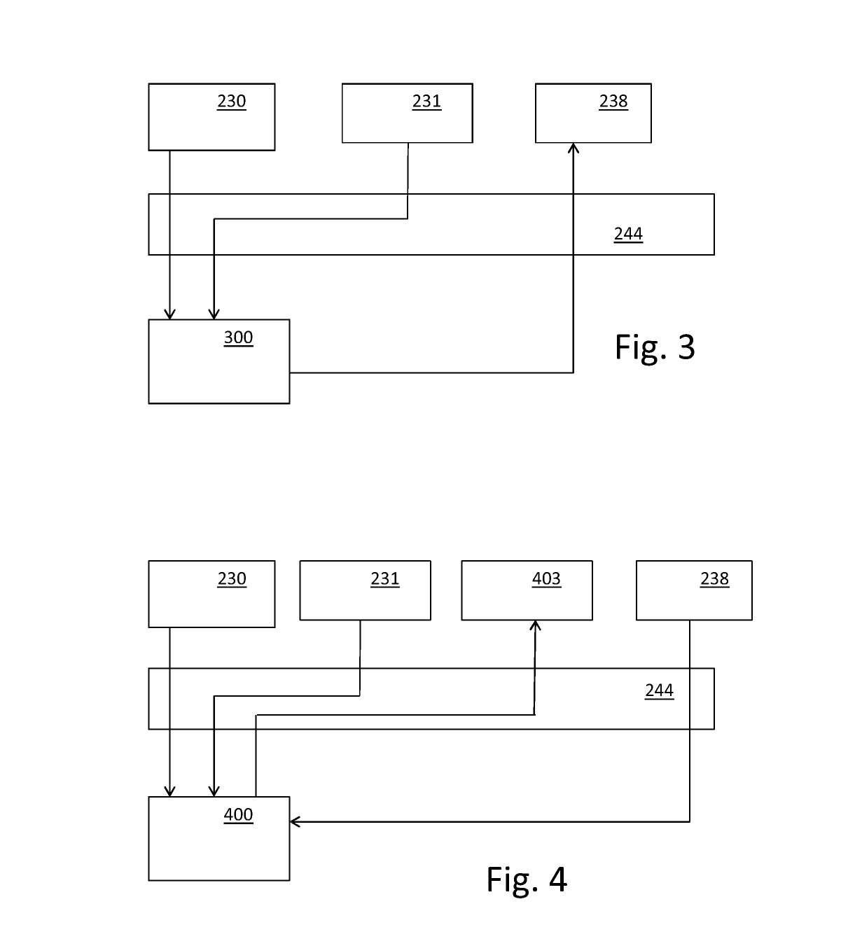

FIG. 3 illustrates the units of the DSP that are involved according to the first embodiment as discussed above, that is, a first and a second vector memory unit 230, 231, an integer memory unit 238, an on-chip network 244 and a vector execution unit 300. The vector execution unit 300 is arranged to receive input data from the vector memory units 230, 231 and process them, and to output the result of the processing in the form of an integer vector through the integer output port 314 to the on-chip network 244. In this example, the resulting integer vector is written to an integer memory unit 238. It could also be fed directly to a functional unit such as another vector execution unit or an accelerator unit to control the processing performed by this functional unit.

Of course, the vector execution unit 300 may also comprise a data output port as shown in FIG. 2.

FIG. 4 illustrates the units of the DSP that are involved according to the second embodiment as discussed above, that is, a first and a second vector memory unit 230, 231, an integer memory unit 238, an on-chip network 244 and a vector execution unit 300. A vector execution unit 400 is arranged to receive input data from the vector memory units 230, 231 and process them, and to output the result of the processing in the form of an output data vector. In this embodiment a third vector memory unit 403 is used to receive the output data vector, but it could instead be output to another functional unit, not shown in FIG. 4, as input data for this functional unit.

The vector execution unit 400 also has an integer input port for receiving an integer vector from an integer memory 238. The decoding unit of the vector execution unit is arranged to use the integer vector to control the processing of the input data received on the two input ports. Typically, the value of the integer data item will be used to determine which function should be performed on the input data items. For example, the function may be that if the integer data item has the value 0 the output data item should be set to 0, whereas if the integer data item has the value 1 the output data item should keep the input value or be the sum, difference, or the product, of the input data items.

As will be understood, the vector execution units 300, 400 which are shown in FIGS. 3 and 4 as having two input data ports could have only one data port or more than two data parts as well. Further, when it is stated in the description that data are read from, or written to, memory units, data could instead be read from or written to any suitable unit in the DSP, for example an accelerator or another execution unit.

The comparison performed according to the first embodiment may be a direct comparison between two data vectors A and B, which, for example, will compare return a value 1 if the value of a data item in the vector A is greater than the value of the corresponding data item in the vector B.

For example, if vector A has the following sequence of data items:

0 1 2 3 4 5 6 7

And vector B has the following sequence of data items:

3 3 3 3 4 4 4 4

The resulting vector from the operation “greater than or equal” would be

0 0 0 1 1 1 1

Because the first three data items are greater in vector B than in vector A, which will return a 0. The fourth and fifth data items in the two vectors are equal and the remaining data items are greater in vector A than in vector B, so the comparison will return a 1. Of course, instead of “greater than or equal” and “smaller than”, one could use “greater than” and “smaller than or equal”.

One input data vector may also be compared to a constant, which may be suitably selected as a threshold value. For each data item in the vector that is greater than or equal to the constant a 1 will be added to the decision vector. For data items smaller than the constant, a 0 will be added to the decision vector. This is particularly useful to filter out noise. The threshold may be set to a certain percentage of the highest value of the input data vector. The decision vector will then be used by a functional unit to process the data vector in a new operation as described in connection with FIG. 4. Using the decision vector, all data items in the data vector that are lower than the threshold may be set to 0. The constant could be taken from any accumulator register, constant register or control register in the vector execution unit.

It is also possible to perform an arithmetic operation on one or both data items before the comparison, for example to square the data items, inverse it, or to use the absolute value. Also, for complex input data it would be possible to use only the real part or the complex part in the comparison.

A non-limiting list of examples would be

|A|>|B|

|A|<B

A>x, x being a constant

Re{A}>Re{B}

Im{A}<y, y being a constant

In a vector execution unit having more than one data path, the vector execution unit will read more than one complex data item at a time, one on each data path. In this case, the data items received on two or more data paths can be processed together, for example multiplied, subtracted or added and the results may be used in the comparison according to the invention. This means that in a typical vector execution unit having four data paths, the data items received on two inputs can be processed together and the data items received on the two remaining inputs can be processed together and the results can be compared to produce the decision vector.

It is also possible to let the instruction decoder perform several operations on each input data item. For example, for complex data items, the real parts and the complex parts of the data items may be compared separately, each comparison giving a decision data item in return. Alternatively, or in addition, one or more arithmetic operations may be performed on the data items before the comparison, so that for example the square value, the absolute value or the inverse value is used in the comparison. Also, as yet another example, a decision data item may be used to indicate if two values are the same. Each comparison will return one decision data item which may be one or more bits. Hence, the decision vector will comprise more than one decision data item for each input data item, each decision data item indicating one property of the input data item.

In this case, the instruction decoder is arranged to select which one of the decision data items related to an input data item is to be used to determine how to process the input data item.

As an example consider an integer vector having 3 bits per value, which has been created by comparison of vectors A and B by subtraction A-B. The bits are as follows:

Bit 0: negative flag=1 if the result was negative, that is, if B>A
Bit 1: zero flag=1 if the result was 0, that is, if A=B
Bit 2: overflow flag=1 if the result is too large, that is greater than a threshold value.

This integer vector could be used to execute, for example, a “select equal” instruction that would select the operand A if the flag in bit 1, that is, the zero flag, was set and operand B if the flag in bit 1 was not set. The integer vector could also be used to execute a “select greater than” instruction, which would select operand A if the flag in bit 0 was 0 and operand B if the flag in bit 0 was 1.

As will be understood, these are merely intended as non-limiting examples. The skilled person could easily apply the general principles of these examples to a wide variety of situations.

What is claimed:

1. A vector execution unit for use in a digital signal processor, said vector execution unit comprising:
A first vector input port for receiving at least a first input data vector from at least a first unit in the digital signal processor, respectively,
An instruction decoding unit arranged to decode instructions received from a program memory of the digital signal processor and control at least one datapath in the vector execution unit to execute the instructions,
A vector output port for feeding the result of the instruction execution to at least another unit in the digital signal processor,
At least one data-path,
said vector execution unit being characterized in that the instruction decoding unit is arranged to control the data-path to perform a comparison related to the first input data vector,
and in that the processor comprises an integer port arranged to output the result of the comparison in the form of a decision vector to a memory unit or a functional unit in the digital signal processor.

2. A vector execution unit according to claim 1, wherein the integer port is also arranged to receive a decision vector of integer data, and the instruction decoding unit is arranged to control the data-path to process the first input data in dependence of the value of the integer data.

3. A vector execution unit according to claim 1, further comprising a second vector input port arranged to receive a second input data vector from a second unit in the digital signal processor, the instruction decoder being arranged to control the data-path to perform the comparison based on the first input data vector and the second input data vector.

4. A vector execution unit according to claim 1, arranged to perform a comparison between the first input data vector and a constant.

5. A vector execution unit according to claim 1, wherein the instruction decoding unit is arranged to control the data-path to perform an arithmetic operation on the first andor second input data vector and use the result of the arithmetic operation in the comparison.

6. A vector execution unit according to claim 5, wherein the instruction decoder is arranged to control the data-path to perform two or more comparisons on the input data item and the decision vector will have one data item indicating the result of each comparison.

7. A vector execution unit according to claim 2, wherein each vector input port is arranged to receive a vector of data, and the instruction decoder is arranged to control the data-path to perform the comparison on one data item from each input port at a time and output a vector of data having one or more data items for each comparison.

8. A vector execution unit according to claim 7, wherein the instruction decoding unit is arranged to control the data-path to perform an arithmetic operation on the first andor second input data vector and use the result of the arithmetic operation in the comparison.

9. A vector execution unit according to claim 1, having a first and a second data-path, the instruction decoding unit being arranged to control the data-paths to perform an arithmetic operation on the input data received on the first and second data-paths and use the result in the comparison.

10. A vector execution unit for use in a digital signal processor, said vector execution unit comprising:
A first vector input port for receiving a first input data vector from at least a first unit in the digital signal processor,
An instruction decoding unit arranged to decode instructions received from a program memory of the digital signal processor and control at least one datapath in the vector execution unit to execute the instructions,
A vector output port for feeding the result of the instruction execution to at least another unit in the digital signal processor,
At least one data-path,
said vector execution unit being characterized in that the processor comprises an integer port arranged to receive a decision vector of integer data,
and in that the instruction decoding unit is arranged to control the data-path to process the first input data in dependence of the value of the integer data.

11. A vector execution unit according to claim 10, wherein each vector input port is arranged to receive respective input data, and the instruction decoder is arranged to perform the comparison on one data item from each vector input port at a time and output a vector of data having one or more data items for each comparison.

12. A vector execution unit according to claim 10, wherein the integer port is arranged to receive a decision vector having more than one integer data item for each input data item, the instruction decoder being arranged to select one of the integer data items for a corresponding input data items and use the selected integer data item to control the processing of the corresponding integer data item.

13. A digital signal processor comprising a program memory, and at least a first vector execution unit arranged to receive and carry out instructions from the program memory, characterized in that the at least first vector execution unit is a vector execution unit according to claim 1.
